(19) United States
(12) Patent Application Publication
(10) Pub. No.: US 2019/0293076 A1
(43) Pub. Date: Sep. 26, 2019

(54) Control method for adjusting rotating speed of multiple fans according to temperature

(71) Applicant: IN WIN DEVELOPMENT, INC., Taoyuan Hsien (TW)

(72) Inventor: Wen-Hsien Lai, Taoyuan Hsien (TW)

(21) Appl. No.: 15/935,713

(22) Filed: Mar. 26, 2018

(51) Int. Cl. F04D 27/00; F04D 25/16; F04D 29/58; G06F 1/20

(52) U.S. Cl. CPC F04D 27/004; F04D 25/166; G06F 9/4401; F04D 29/584; G06F 1/20; F04D 27/001

(57) ABSTRACT

A control method for adjusting rotating speed of multiple fans according to temperature of the present invention includes a micro controller circuit board and one or more fans. The circuit board is connected with one or more fans. The rotating speed of the fans are controlled by a PWM duty cycle and the signals of rotating speed are transmitted back to an MCU. Therefore, the rotating speed is adjusted consistently and proportionally with respect to the change in temperature, allowing a computer or server casing to have optimized cooling efficiency.

### BACKGROUND OF THE INVENTION

### a) Field of the Invention

The present invention relates to a control method for adjusting rotating speed of multiple fans according to temperature, and particularly to a method which realizes the control of rotating speed for one or more fans.

### b) Description of the Prior Art

Nowadays, most servers or computer systems are equipped with fans for cooling, to avoid damaging the servers or computer systems due to overheating. Depending upon the change in temperature, the prior art utilizes a PWM (Pulsed Width Modulation) signal to adjust the PWM duty cycle of the fans, thereby increasing the air flow for cooling. However, each fan has its own characteristics. As shown in FIG. 1, a micro controller circuit board 100 of an ordinary fan sold in the markets is connected with one or more fans 200. The rotating speed of the fans 200 is controlled by the PWM duty cycle and the signals of rotating speeds are transmitted back to the micro controller 300. However, for all the fans, it is not necessary that the PWM duty cycle is always in a linear relation to the rotating speed; especially when a casing is deployed with all kinds of elements. The performance of the fan speed will be affected by the variation of wind resistance and wind pressure that when the PWM duty cycle is increased by 10%, the actual rotating speed of the fans is only increased by 5%. In addition, the condition will be even more complicated when a fan wall is formed inside the casing by various fans. Therefore, the overall cooling efficiency of the fans cannot achieve the expected effect, which requires a feasible solution.

### SUMMARY OF THE INVENTION

The primary objective of the present invention is to provide a control method for adjusting the rotating speed of multiple fans according to temperature, wherein when a boot up system is activated, an MCU (Micro Controller Unit) outputs the signals of PWM duty cycle in an ascending or descending order. Next, after a while when the rotating speed tends to be stable, the fan speed is accessed by the MCU to build up a relation table of the PWM duty cycle with respect to RPM (Revolutions Per Minute). When the boot up system enters the run mode, the rotating speed and the corresponding PWM duty cycle can then be provided according to temperature. Therefore, the characteristics of each fan can be adjusted depending upon the change in temperature, which optimizes the cooling efficiency.

### BRIEF DESCRIPTION OF THE DRAWINGS

FIG. 1 shows a schematic view of a conventional fan.

FIG. 2 shows a flow diagram of a method for controlling rotating speed of fans, according to the present invention.

FIG. 3 shows data charts of a fan speed table, according to the present invention.

FIG. 4 shows curves of temperature versus rotating speed of the fans, according to the present invention.

### DETAILED DESCRIPTION OF THE PREFERRED EMBODIMENTS

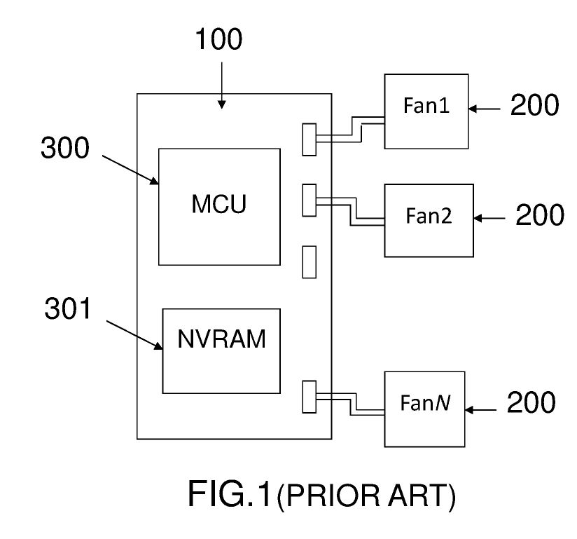

Referring to FIG. 1, a micro controller circuit board 100 of the present invention is connected with one or more fans 200. The rotating speed of the fans 200 is controlled by the PWM duty cycle, and the signals of the rotating speed are transmitted back to an MCU 300 to build up a fan speed table.

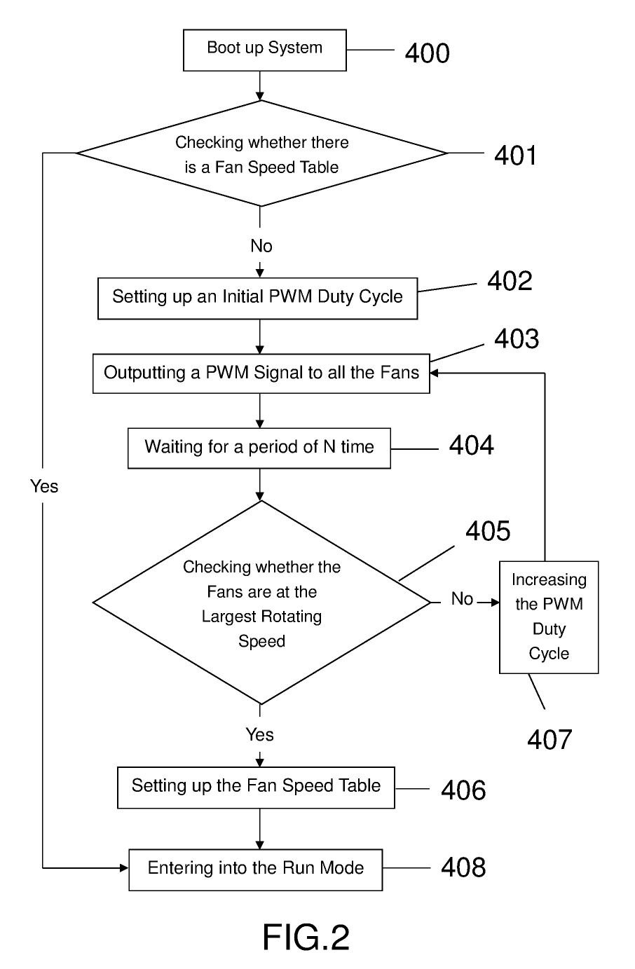

Referring to FIG. 2, it shows a flow diagram of a method for controlling the rotating speed of the fans. First, in step 400, the boot up system is activated. Upon booting up, the MCU outputs a PWM duty cycle to each fan in an ascending or descending order; for example, the PWM duty cycle is outputted slowly in the ascending order by 10%, such as 30%, 40%, 50%, etc. After the PWM duty cycle is outputted ascendingly, and when the rotating speed tends to be stable after waiting for a period of time, the rotating speed of the fans is accessed again, and step 401 proceeds after the boot up system is activated.

In step 401, it a fan speed table is determined, then it proceeds to step 408 proceeds and the run mode is entered; otherwise, step 402 proceeds.

In step 402, an initial PWM duty cycle is set up to increase the rotating speed, thereby increasing the air flow for cooling. Next, step 403 proceeds.

In step 403, the PWM signals are outputted to all the fans and then step 404 proceeds.

In step 404, a period of (N) time is waited and then step 405 proceeds.

In step 405, the PWM duty cycle of the fans is checked for the largest rotating speed. If the result is yes, then step 406 proceeds; otherwise, step 407 proceeds.

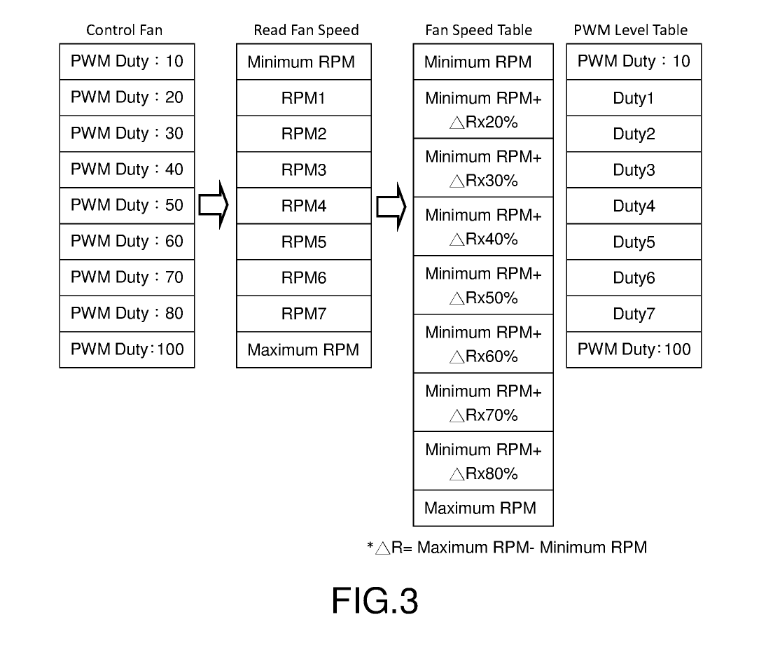

In step 406, a relation table of the PWM duty cycle with respect to the rotating speed (RPM) is built up (as shown in FIG. 3), and then step 408 proceeds.

In step 408, when the PWM duty cycle reaches 100% (the largest rotating speed), the recording stops and then the temperature controlled run mode is entered.

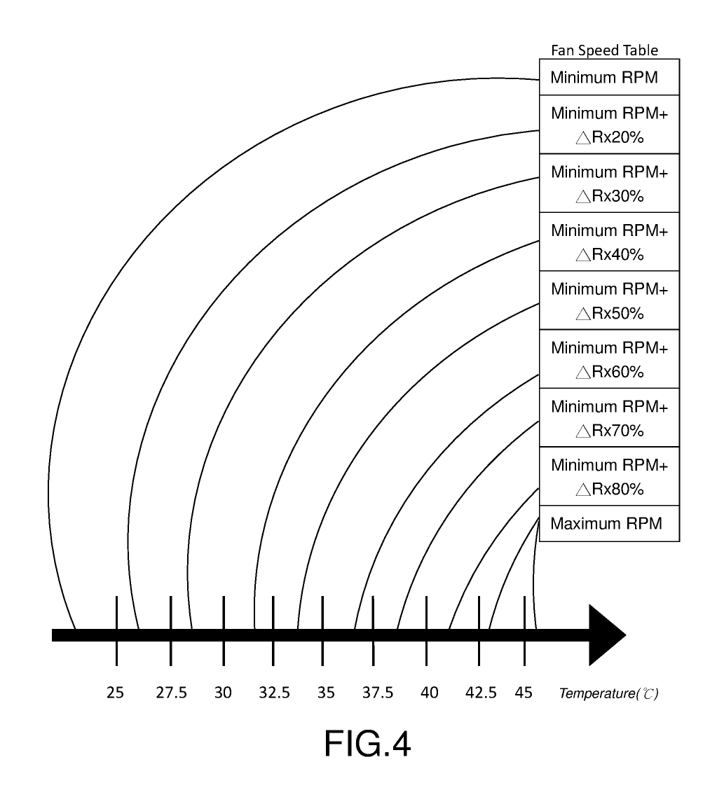

The abovementioned PWM duty cycle and the fan speed table can be used to build up the charts of the fan speed tables corresponding to the temperature trend as shown in FIG. 4, and then the run mode can provide the rotating speed and the corresponding PWM duty cycle according to the temperature. Accordingly, each fan is able to correspond to its own characteristics to deal with the change in temperature, thereby providing the optimized cooling efficiency.

In step 407, if the rotating speed of the fans is not the largest speed, then the PWM duty cycle is increased. Next, step 403 is returned to output the PWM duty cycle to all the fans.

The abovementioned recorded data can be also used to check the failure condition of the fans. When the PWM duty cycle of one fan cannot reach the requested rotating speed, for example, the largest rotating speed can only reach 75%, the fan failure signal is produced to notify the boot up system. The abovementioned fan speed table data can be also recorded in an NVRAM (Non-Volatile Random Access Memory) 301 or a storage media, and is stored in the micro controller circuit board 100 (as shown in FIG. 1). Therefore, when the server or computer system is booted up in the next time, the process of building up the fan speed table can be omitted, and the run mode can be entered directly as in step 408. On the other hand, for some kinds of fans, the rotating speed is driven by the change in voltage; therefore, if the rotating speed of the fans is to be driven by the change in voltage, the operation method is the same as for the PWM duty cycle, wherein the abovementioned PWM duty cycle parameter is replaced by the voltage.

In conclusion, according to the above description of the embodiments of the present invention, the present invention comprises an MCU circuit board and one or more fans. The MCU is activated and the PWM duty cycle is outputted to each fan in an ascending or descending order. After waiting for a period of time, the rotating speed is accessed and the server or computer system is operating. At this time, the rotating speed data is used depending upon the casing temperature, so that the rotating speed of each fan can be adjusted proportionally.

It is of course to be understood that the embodiments described herein is merely illustrative of the principles of the invention and that a wide variety of modifications thereto may be affected by persons skilled in the art without departing from the spirit and scope of the invention as set forth in the following claims.

What is claimed is:

1. A control method for adjusting rotating speed of multiple fans according to temperature, comprising the following steps:
(1) activating a boot up system and an MCU outputting a PWM duty cycle to the fans while booting up a server or computer system, with the rotating speed of fans being accessed again when the rotating speed tends to be stable after waiting for a period of time;
(2) determining whether there is a fan speed table, and if there is no fan speed table, then setting up an initial PWM duty cycle to increase the rotating speed, thereby increasing air flow of the fans for cooling;
(3) if there is a fan speed table, it enters a run mode in step (6);
(4) after setting up the initial PWM duty cycle, it outputs a PWM signal to all the fans;
(5) after waiting for a period of time, it checks whether the PWM duty cycle of the fans is the largest rotating speed, and if it is the largest rotating speed, then it builds up a fan speed table; otherwise, it will increase the PWM duty cycle and returns to step (4) to output the PWM duty cycle to all the fans; and
(6) after the fans are at the largest rotating speed and the fan speed table is set up, it will enter the run mode.

2. The control method for adjusting rotating speed of multiple fans according to temperature defined in claim 1, wherein in step (1) and after the boot up system is activated, the MCU outputs a PWM duty cycle to each fan in an ascending or descending order.

3. The control method for adjusting rotating speed of multiple fans according to temperature defined in claim 1, wherein in step (5) if the PWM duty cycle of one fan does not reach the requested rotating speed, a fan failure signal is produced to notify the boot up system.

4. The control method for adjusting rotating speed of multiple fans according to temperature defined in claim 1, wherein in step (2) the fan speed table data is recorded in an NVRAM or a storage media, so that the fan speed table data is stored in the MCU circuit board to omit the process of building up the fan speed table when a server or computer system boots up in a next time.

5. The control method for adjusting rotating speed of multiple fans according to temperature defined in claim 1, wherein in the steps of the control method, the PWM duty cycle parameter is replaced by voltage to enter into the run mode.
